(19) United States
(12) Patent Application Publication
(10) Pub. No.: US 2020/0265510 A1
(43) Pub. Date: Aug. 20, 2020

(54) ELECTRONIC MANAGERIAL DECISION REQUEST FORM UPDATING METHOD AND SYSTEM

(71) Applicant: SUMITOMO MITSUI BANKING CORPORATION, Tokyo (JP)

(72) Inventors: Kiyonori UGAJIN, Tokyo (JP); Kazuya IKEDA, Tokyo (JP); Fumitaka KATO, Tokyo (JP); Yoshiaki YODA, Tokyo (JP); Masato HAYASHI, Tokyo (JP); Takuya MIZUGUCHI, Tokyo (JP); Sho MATSUO, Tokyo (JP); Masato KANO, Tokyo (JP)

(21) Appl. No.: 15/749,031

(22) PCT Filed: Jul. 31, 2015
(86) PCT No.: PCT/JP2015/003892

§ 371 Date: Jan. 30, 2018

(51) Int. Cl. G06Q 40/02; G06Q 10/06

(52) U.S. Cl. CPC G06Q 40/025; G06Q 10/06

(57) ABSTRACT

In the case of financing across countries, a credit application will be circulated across a plurality of countries, a plurality of branches, and a plurality of departments. Therefore, while a credit application is being circulated, the credit data of a financing related party may be updated. Therefore, there is a need for a method and system capable of decision on a credit application and in turn executing a loan on the basis of the latest credit data. There are provided a method and system capable of reflecting the credit data of a financing related party when updated even before decision, on a credit application, and capable of decision on a credit application and in turn executing a loan on the basis of the latest credit data.

### TECHNICAL FIELD

The present invention relates to a method and system for updating an electronic credit application in crediting works. Specifically, the present invention relates to a system and method capable of reflecting the credit data of a financing related party when updated even before decision, on a credit application, and capable of decision and in turn executing a loan on the basis of the latest credit data.

### BACKGROUND ART

In recent years, as the business scale in overseas expands, the number of global corporations having offices not only in one country but also in a plurality of countries has been increasing. Also in financial institutions, a branch is established in each country in order to deal with global corporations. Thus, each corporation is able to apply for a loan in its own country and be also financed in another country through a branch in each country of a financial institution. More specifically, for example, “X” Corporation headquartered in “A” country submits, to a branch in “A” country of a financial institution, a financing application to its own factory located in “B” country. Then, a staff in a front office of the branch in “A” country negotiates with “X” Corporation and prepares a credit application. The prepared credit application is confirmed and approved by a staff in a front middle office of the branch in “A” country, and is circulated to a credit department in “C” country. For the circulated credit application, credit decision is made by a staff of a credit department in “C” country, such as whether the circulated credit application fulfills terms of credit. In the case where the credit application is decided by the credit department, the check of a contract document and the like is performed by a staff of a middle back office of a branch in “B” country of the financial institution, and a loan is executed by a staff in a back office of this branch. Thus, “X” Corporation can be financed from the branch in “B” country.

As explained above, particularly in the case of financing across countries in a loan work by a financial institution, the credit application prepared in a responsible office (in the case of above example, the branch in “A” country) will be circulated across a plurality of countries, a plurality of branches, and a plurality of departments. Therefore, while the credit application is being drafted and circulated, the credit data of a corporation having applied for finance or a related company or the like thereof (hereinafter, collectively referred to as a “financing related party”) may be updated (e.g., a data that a subsidiary has been bankrupt). In this case, credit decision should be made on the basis of the credit application reflecting the latest credit data, but conventionally credit data is not reflected after drafting a credit application until decision, and only a data item which does not affect the credit application is passed back by paper base so as to be updated. Therefore, there is a need for a method and system capable of reflecting the credit data of a financing related party when updated even before decision, on a credit application, and capable of decision and in turn executing a loan on the basis of the latest credit data.

### SUMMARY OF INVENTION

There is provided a method for updating an electronic credit application in crediting works, the method includes:

receiving credit application content data input by a first staff;

preparing credit application data based on the received credit application content data;

receiving a first circulation instruction from the first staff;

circulating the credit application data to a second staff in response to the first circulation instruction;

receiving a second circulation instruction from the second staff;

approving the credit application data in response to the second circulation instruction and circulating the credit application data to a third staff;

receiving a third circulation instruction from the third staff;

approving the credit application data in response to the third circulation instruction and circulating the credit application data to the second staff;

receiving first update data of the credit application data; and

updating the credit application data based on the first update data.

Moreover, the method described in the previous paragraph further comprises:

receiving contract content data input by the second staff;

preparing contract data based on the received contract content data;

receiving a fourth circulation instruction from the second staff;

circulating the contract data to a fourth staff in response to the fourth circulation instruction;

receiving a fifth circulation instruction from the fourth staff;

approving the contract data in response to the fifth circulation instruction and circulating the contract data to a fifth staff;

receiving an execution instruction from the fifth staff;

executing a loan procedure based on the contract data in response to the execution instruction;

receiving second update data of the contract data; and

updating the contract data based on the second update data.

Furthermore, the method described in the previous two paragraphs further comprises:

updating status data indicating credit application approval and loan execution statuses, in response to any one of the first to fifth circulation instructions, or the execution instruction;

determining, based on the status data, whether or not the credit application data or the contract data can be updated;

and determining, based on the status data, a staff who can update the credit application data or the contract data.

As explained above, the present invention enables to reflect the credit data of a financing related party when updated even before decision, on a credit application, and enables to make a decision and in turn execute a loan on the basis of the latest credit data.

### BRIEF DESCRIPTION OF DRAWINGS

FIG. 1 illustrates a system configuration according to an embodiment of the present invention;

FIG. 2 illustrates the data stored in a credit application data storage part according to an embodiment of the present invention;

FIG. 3 illustrates the data stored in a control card data storage part according to an embodiment of the present invention;

FIG. 4 illustrates the data stored in a staff data storage part according to an embodiment of the present invention;

FIG. 5 illustrates the data stored in an investigation card data storage part according to an embodiment of the present invention;

FIG. 6 is a flow chart illustrating an example of a loan execution work directed to a global corporation;

FIG. 7 illustrates a relationship between FIG. 7A and FIG. 7B;

FIG. 7A is a flow chart illustrating a loan execution procedure using a system according to an embodiment of the present invention; and

FIG. 7B is the flow chart illustrating the loan execution procedure using the system according to an embodiment of the present invention.

### DESCRIPTION OF EMBODIMENTS

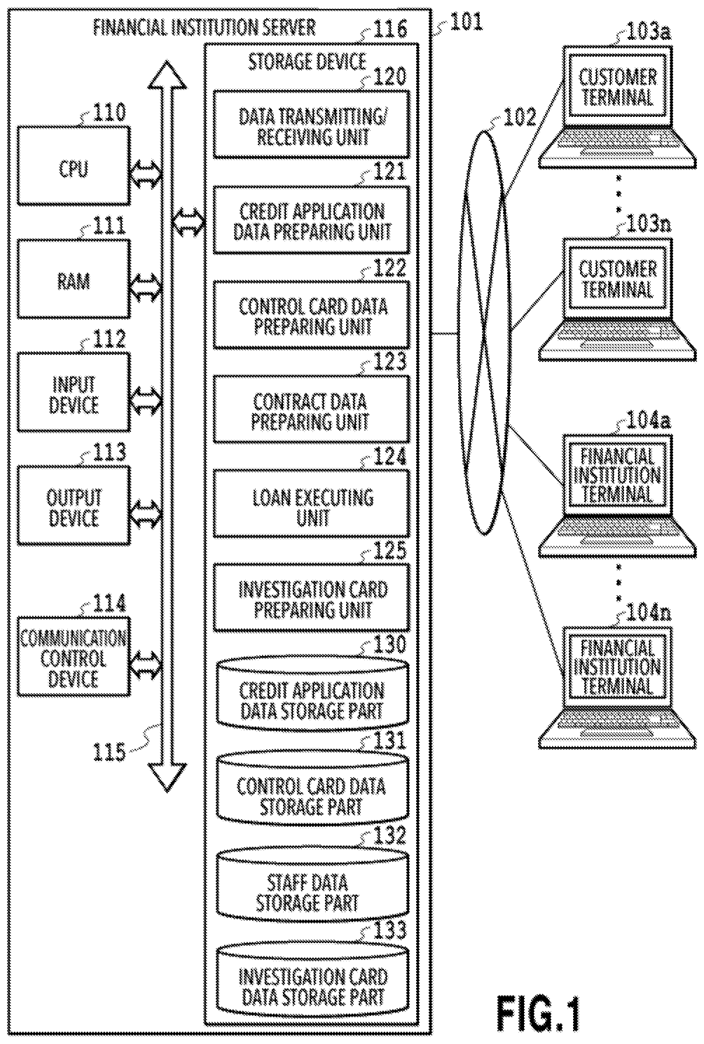

The overview of an electronic credit application system according to an embodiment of the present invention will be explained. FIG. 1 illustrates a system configuration according to an embodiment of the present invention. In FIG. 1, a financial institution server 101 installed in a data center or the like is configured so as to communicate with customer terminals 103a, . . . , 103n (hereinafter, collectively referred to as a “customer terminal 103”) and financial institution terminals 104a, . . . , 104n (hereinafter, collectively referred to as a “financial institution terminal 104”) through a network 102 (e.g., the Internet). Note that, while the financial institution server 101 is illustrated as a single server in FIG. 1, it can also be configured as a distributed system including a plurality of servers.

The customer terminal 103 is the terminal for a customer to use. In the present invention, the customer is a user customer or the like related to a finance contract. A user customer can access the financial institution server 101 and for example apply for a loan through a dedicated site, by using the customer terminal 103. Moreover, a user customer can also apply for a loan based on a finance contract while referring to the proposal data related to the financing prepared by a front office, by using the customer terminal 103. Furthermore, a user customer can sign a finance contract while referring to the contract data prepared by a front middle office, by using the customer terminal 103.

The financial institution terminal 104 is the terminal for a staff of each branch in a financial institution to use, the financial institution performing financing transaction services. Upon receipt of a loan application from a user customer, a financial institution staff can prepare, for the user customer, the proposal data related to financing and negotiate with the user customer, by using the financial institution terminal 104. Moreover, a financial institution staff can access the financial institution server 101, prepare, confirm (approve), and decide a credit application (credit application data) by using the financial institution terminal 104. Furthermore, in the case where credit data has been updated, a financial institution staff can update the approved credit application data by using the financial institution terminal 104. Then, a financial institution staff can execute the loan procedure based on a finance contract via the financial institution server 101 by using the financial institution terminal 104.

The financial institution server 101 can receive a loan application from a user customer via the customer terminal 103 and can display this application on the financial institution terminal 104. Moreover, the financial institution server 101 can receive the prepared and updated credit application data, contract data, and investigation card data (customer master data including credit data) from the financial institution terminal 104 and store the same into a storage device. Note that, the credit data serving as a base of investigation card data may be collected by another system, or the financial institution server 101 can also receive this credit data from another system and store the same into the storage device as the investigation card data. Furthermore, upon receipt of a loan execution instruction from the financial institution terminal 104, the financial institution server 101 can execute a loan procedure.

Next, the configuration of the financial institution server 101 will be explained in detail. Note that, in FIG. 1, a single computer system is assumed and only a required functional configuration is illustrated.

The financial institution server 101 has a configuration in which a RAM 111, an input device 112, an output device 113, a communication control device 114, and a storage device 116 constituted from a nonvolatile storage media (ROM, HDD, or the like) are connected to a CPU 110 via a system bus 115. The storage device 116 includes a program storage area for storing a software program for exhibiting each function of the electronic credit application system, and a data storage area for storing the data handled by this software program. Each unit in the program storage area to be explained hereinafter is actually an independent software program or the routine, component, and the like, and exhibits each function by being called from the storage device 116 by the CPU 110, expanded into a work area of the RAM 111, and sequentially executed while referring to a database and/or the like as required.

Next, the software program stored in the program storage area in the storage device 116 includes, if only units related to the present invention are listed, a data transmitting/receiving unit 120, a credit application data preparing unit 121, a control card data preparing unit 122, a contract data preparing unit 123, a loan executing unit 124, and an investigation card data preparing unit 125. These units are configured to be executed by the CPU 110.

The data transmitting/receiving unit 120 exchanges data with the customer terminal 103 and financial institution terminal 104 via the network 102.

The credit application data preparing unit 121 prepares credit application data, on the basis of the data related to the credit application which is input via the financial institution terminal 104, and stores the same into a credit application data storage part 130. Moreover, the credit application data preparing unit 121 searches credit application data stored in the credit application data storage part 130 in response to a request from the financial institution terminal 104, and updates the corresponding data in the credit application data storage part 130 in response to a request for update of a credit application via the financial institution terminal 104. Furthermore, the credit application data preparing unit 121 updates the corresponding credit application data in the credit application data storage part 130 in response to a request for approval, decision, or the like of a credit application via the financial institution terminal 104.

The control card data preparing unit 122 prepares control card data for managing a credit application status and the like at the same timing with the timing of preparing the credit application data, and stores the same into a control card data storage part 131. Moreover, the control card data preparing unit 122 updates the corresponding control card data in the control card data storage part 131 in response to a request for approval and/or decision of the credit application via the financial institution terminal 104.

The contract data preparing unit 123 prepares contract data (not illustrated) on the basis of the data related to a contract document which is input via the financial institution terminal 104, and stores the same into the storage part. Moreover, the contract data preparing unit 123 searches the contract data stored in the storage part in response to a request from the financial institution terminal 104, and updates the corresponding data stored in the storage part in response to a request for update of a contract document via the financial institution terminal 104.

The loan executing unit 124 executes a loan procedure corresponding to the content of an application from a user customer on the basis of credit application data, contract data, and/or the like in response to a request from the financial institution terminal 104.

The investigation card data preparing unit 125 prepares, on the basis of customer master data including credit data which is input via the financial institution terminal 104 or which is collaborating with another system, investigation card data and stores the same into an investigation card data storage part 133. Moreover, the investigation card data preparing unit 125 updates, on the basis of the update data via the financial institution terminal 104 or the update data which is collaborating with another system, the investigation card data stored in the investigation card data storage part 133.

The data storage area in the storage device 116 includes, if only parts related to the present invention are listed, the credit application data storage part 130, the control card data storage part 131, a staff data storage part 132, and the investigation card data storage part 133. Any of them is a predetermined storage area reserved inside the storage device 116.

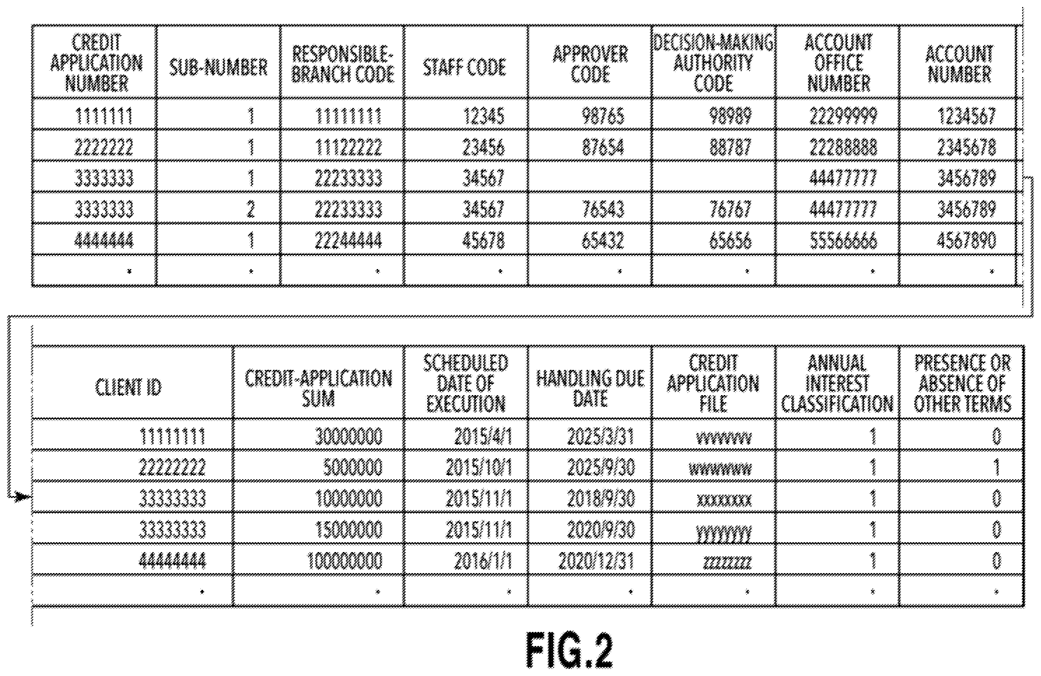

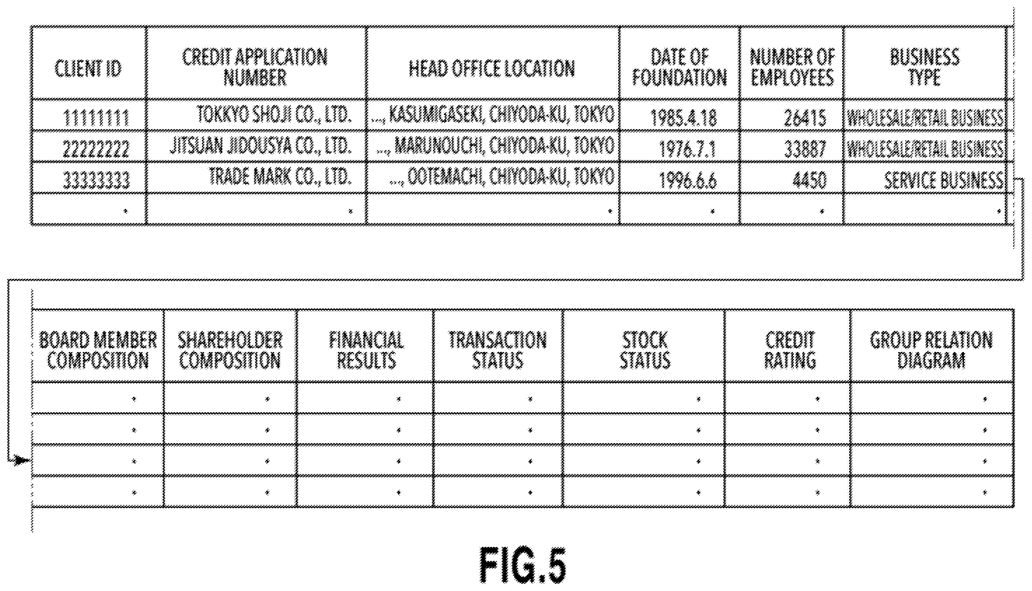

The credit application data storage part 130 stores the data related to a credit application in a financing transaction. FIG. 2 illustrates the data stored in the credit application data storage part 130 according to an embodiment of the present invention. In the credit application data in FIG. 2, the followings are stored: a “credit application number” uniquely indicating a credit application; a “sub-number” indicating the version of the credit application; a “responsible-branch code” uniquely indicating the responsible office having prepared the credit application data; a “staff code” uniquely indicating a creator (front office staff) of the credit application data; an “approver code” uniquely indicating the approver (front middle office staff) of the credit application data; a “decision-making authority code” uniquely indicating the decision-making authority (credit department staff) of the credit application data; an “account office number” uniquely indicating the account office of a client of a financial institution; a “managing-office number” uniquely indicating the managing office of the client; an “account number” indicating the account number of the client; a “client ID” uniquely indicating a client (this ID is linked to investigation card data (FIG. 5)); a “credit-application sum” indicating a credit-application sum; “scheduled date of execution” indicating the scheduled date of executing a loan; a “handling due date” indicating the handling due date of the credit application; a “credit application file” for storing an electronic credit application file or indicating a storage destination; an “annual interest classification” indicating an annual interest classification; and “presence or absence of other terms” indicating the presence or absence of other terms. The record of the credit application data in FIG. 2 is uniquely indicated by the “credit application number” and the “sub-number.” For example, in updating and registering credit application data, the credit application data is registered with the “sub-number” being sequentially increased. Therefore, in the case of searching the same credit application data (the “credit application number” is the same), the data whose “sub-number” is the highest can be acquired as the credit application data of the latest version. In the “annual interest classification”, a numerical value (1: 365 day base, 2: 360 day base) indicating an annual interest base for loan can be set. In the “presence or absence of other terms”, a numerical value (0: without other terms, 1: with other terms) indicative of the presence or absence of the terms other than the terms of the present data can be set. For example, in the case of “1: with other terms”, other terms of data except for the present data can also be referred to.

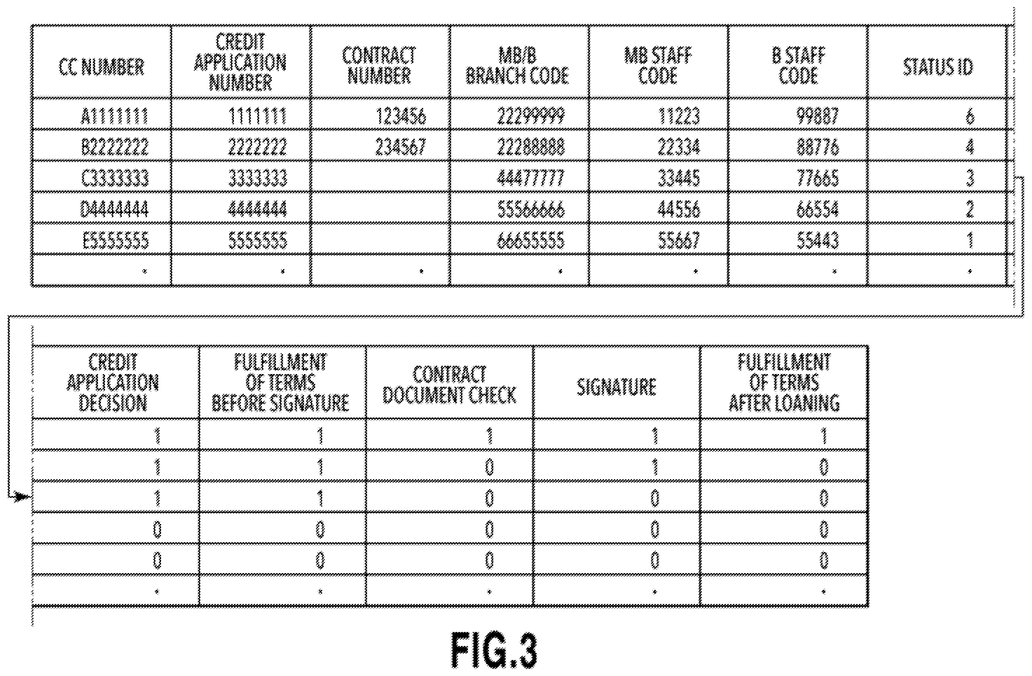

The control card data storage part 131 stores the data for managing the credit application and loan status in crediting works. In an embodiment, the present data is additionally prepared, at the timing when the credit application data to be stored into the credit application data storage part 130 is prepared. FIG. 3 illustrates the data stored in the control card data storage part 131 according to an embodiment of the present invention. In the control card data in FIG. 3, the followings are stored: a “CC number” uniquely indicating a control card; a “credit application number” uniquely indicating a credit application (this data is linked to the credit application data (FIG. 2)); a “contract number” uniquely indicating a contract document (contract data) (this is to be linked to the contract data, so in the case where a contract document has not been prepared yet, null data or the like is set); an “MB/B branch code” uniquely indicating a branch having middle back/back offices, an “MB staff code” uniquely indicating a staff (middle back office staff) who checks a decided credit application and a contract document; a “B staff code” uniquely indicating a staff (back office staff) who executes a loan; a “status ID” indicative of the credit application approval and loan execution statuses; “fulfillment of terms before signature” indicating whether or not the terms of loan to be confirmed before signing a contract document have been fulfilled; “contract document check” indicative of the check status of the contract document; a “signature” indicative of the signature status of the contract document; and “fulfillment of terms after loaning” indicating whether or not the terms of loan to be confirmed after executing a loan have been fulfilled. In the “status ID”, a numerical value indicative of a credit application approval status and/or like (e.g., 0: credit application in preparation, 1: waiting for approval of credit application, 2: credit application approved, 3: credit application decided, 4: waiting for contract to be checked, 5: contract checked, 6: a loan executed) can be set. In the “fulfillment of terms before signature” and the “fulfillment of terms after loaning”, a numerical value (e.g., 0: incomplete (not fulfilled), 1: complete (fulfilled)) indicating a fulfillment status of the terms of loan in each case can be set. Moreover, in the “contract document check”, a numerical value (e.g., 0: before checking, 1: in checking (in modifying), 2: checked) indicating a check status of the contract document can be set.

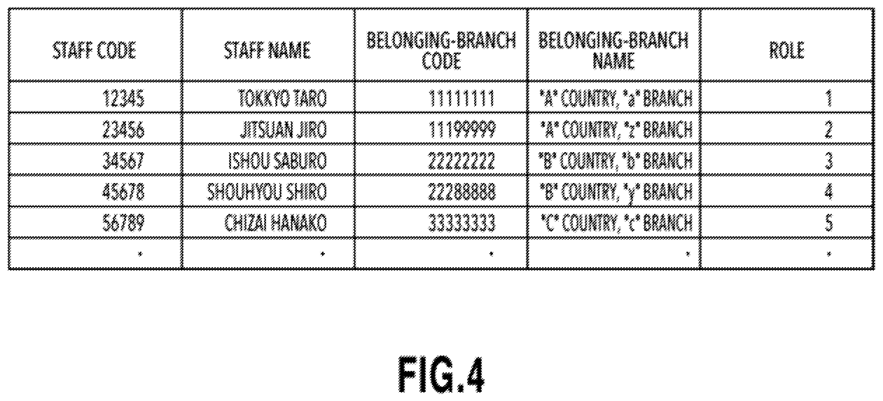

The staff data storage part 132 stores the data related to a staff in the financial institution. FIG. 4 illustrates the data stored in the staff data storage part 132 according to an embodiment of the present invention. In the staff data in FIG. 4, the followings are stored: a “staff code” uniquely indicating a staff (this code is linked to each staff code in the credit application data (FIG. 2) and control card data (FIG. 3)); a “staff name” indicative of the name of the staff, a “belonging-branch code” uniquely indicating a branch to which the staff belongs; and a “role” indicative of the role of the staff. In the “role”, a numerical value indicative of the role of the staff (e.g., 0: others, 1: front, 2: front middle, 3: middle back, 4: back, 5: credit department) can be set.

In the investigation card data storage part 133, customer master data including credit data is stored. FIG. 5 illustrates the data stored in the investigation card data storage part 133 according to an embodiment of the present invention. In the investigation card data in FIG. 5, the followings are stored: a “client ID” uniquely indicating the client (customer); a “client name” indicative of the name of the client; a “head office location” indicative of the head office address of the client; “date of foundation” indicative of the date of foundation of the client; the “number of employees” indicative of the number of employees of the client; a “business type” indicative of the business type of the client; “board member composition” indicative of the board member composition of the client; “shareholder composition” indicative of the shareholder composition of the client; “financial results” indicative of the financial results of the client; a “transaction status” indicating the transaction status of the client; a “stock status” indicative of the stock status (either of listed or unlisted, listed market, stock price, or the like) of the client; “credit rating” indicating a credit rating which is an evaluation result of the credibility of the client given by a credit rating agency or the like; and a “group relation” indicating a group relation of the client. Note that, the data items of “board member composition” and thereafter can also be managed with a plurality of items, a plurality of records, or another data table depending on the content. Note that the investigation card data is assumed to be registered in advance in order to prepare a credit application and/or execute a loan on the basis of this data.

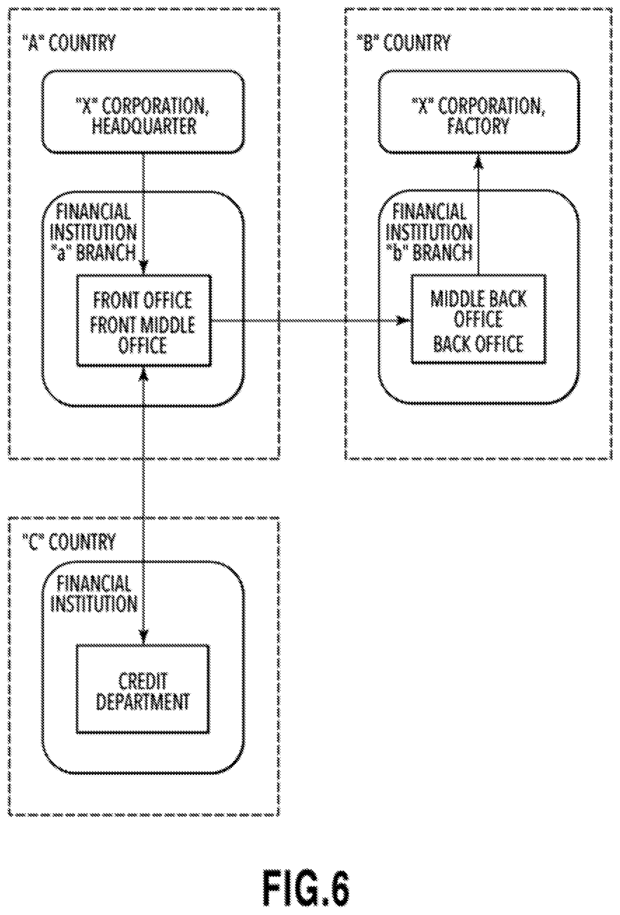

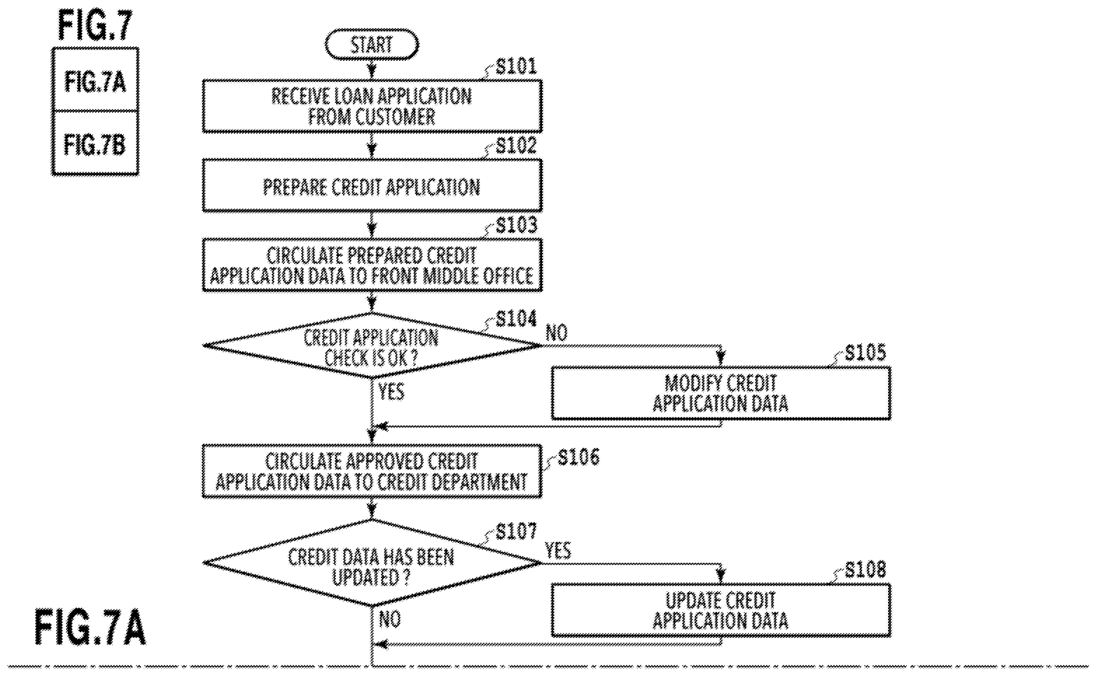

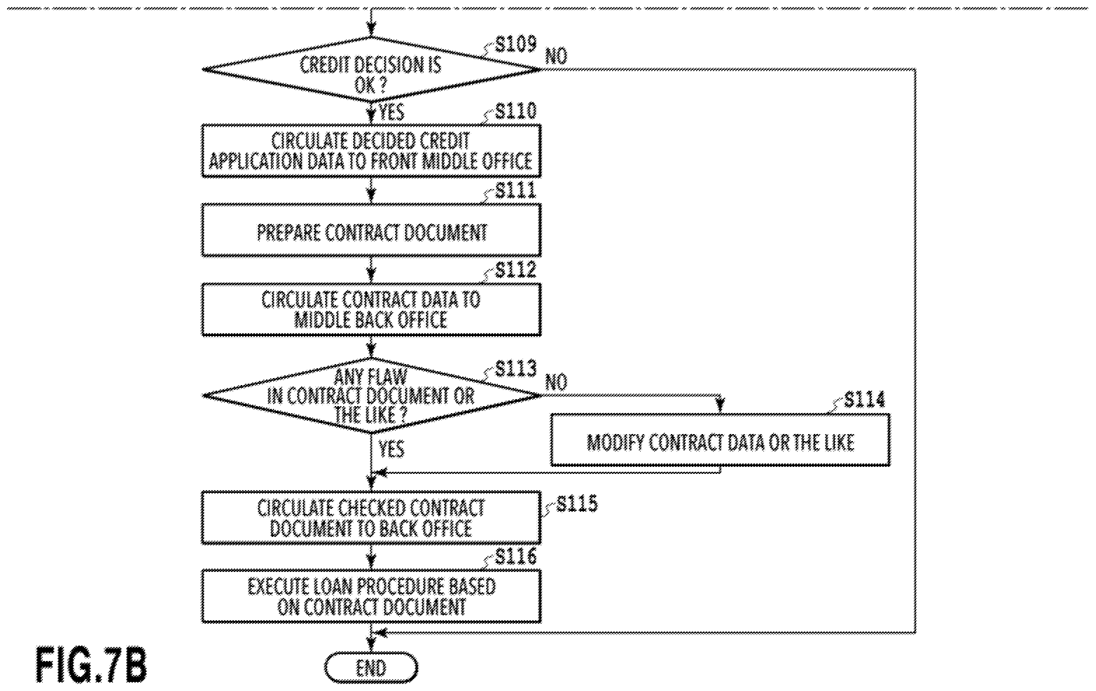

Next, the loan execution procedure using the system according to an embodiment of the present invention will be explained along a flow with reference to the flow charts of FIGS. 6, 7A and 7B (hereinafter, FIGS. 7A and 7B will be collectively referred to as FIG. 7), and the data of FIGS. 2 to 5. FIG. 6 is a flowchart illustrating an example of a loan execution work directed to a global corporation. In FIG. 6, a case is assumed where “X” Corporation headquartered in “A” country wishes to be financed for its own factory located in “B” country. A staff in the head quarter of “X” Corporation applies for financing to “a” branch of a financial institution in “A” country. This is performed through visiting an office, via a telephone, or via a dedicated site or the like. A staff of a front office of “a” branch negotiates with “X” Corporation and prepares a credit application (credit application data) on the basis of the loan application and the investigation card data (FIG. 5) related to “X” Corporation. Next, the prepared credit application is circulated to a front middle office, and the credit application content is checked by a staff of this department. If there is no problem in the check by the front middle office, the credit application is approved and circulated to a credit department of a financial institution located in “C” country. A staff of the credit department determines (makes a credit decision about) whether or not a customer of the destination scheduled to be financed fulfills the terms of credit, and decides the credit application in the case where it is fulfilled. The decided credit application is again circulated to the front middle office. A staff of the front middle office prepares a contract document (contract data) for a finance contract with the customer in response to the decision on the credit application. The prepared contract document is presented to the customer and signed. Next, from the front middle office, the signed contract document and the decided credit application are circulated to “b” branch of a financial institution in “B” country. A staff of the middle back office of “b” branch checks the contract document and credit application. If there is no problem as the result of checking, a loan is executed for a factory of “X” Corporation by a staff of the back office of the “b” branch, on the basis of the contract document. The above-described series of crediting works or a part thereof are performed via the system.

FIG. 7 is the flow chart illustrating the loan execution procedure using the system according to an embodiment of the present invention. First, in Step 101, the data transmitting/receiving unit 120 receives a loan application via the customer terminal 103 from a user customer. This is performed, for example, by the user customer who accesses a dedicated site by using the customer terminal 103 and inputs the contents of the application and then depresses an application button.

Upon receipt of the loan application from the customer terminal 103, a staff of a front office prepares a credit application by using the financial institution terminal 104 (Step 102). This is also performed by accessing a dedicated site. On the basis of the credit application content (input data) input by the staff, the credit application data preparing unit 121 prepares the credit application data (FIG. 2) and stores the same into the credit application data storage part 130. Moreover, once the credit application data is prepared, the control card data preparing unit 122 prepares control card data (FIG. 3) and stores the same into the control card data storage part 131. In this case, the “credit application number” uniquely indicative of this credit application data is set in the control card data (FIG. 3). Thus, the credit application data (FIG. 2) and the control card data (FIG. 3) are linked. Moreover, at the time of preparing the control card data, “0: credit application in preparation” is set to the “status ID” of this data. Note that, in the case where the “status ID” is “0: credit application in preparation”, the control can also be made by using the “staff code” of the credit application data (FIG. 2) so that only the staff who prepared can update the credit application data. This can be controlled, for example, so that each staff logs in a dedicated site, and it is determined whether or not the code is the staff code corresponding to the staff who has logged in, and only in the case where it corresponds, the credit application data can be updated, while in the case where it does not, the credit application data is just for reference. Note that the control of an updater using this “status ID” is true also in each status hereinafter, and each status can control a staff who can update.

Next, the data transmitting/receiving unit 120 receives, from the staff of the front office, an instruction to circulate the credit application data via the financial institution terminal 104, and circulates the credit application data prepared in Step 102 to the front middle office (Step 103). This is performed by, for example, the control card data preparing unit 122 which updates the “status ID” of the control card data (FIG. 3) to “1: waiting for approval of credit application” and the “approver code” of the credit application data (FIG. 2) to the staff code (from the staff data of FIG. 4) of the circulation destination. Note that the staff code of the circulation destination can also be specified by the staff of the front office via the financial institution terminal 104, or a circulation route is held as data in advance so that the staff code of the circulation destination can also be set in accordance with this data.

Once the credit application data is circulated to the front middle office, the staff of the front middle office checks the credit application content (Step 104). In the case where there is no problem in this check, the credit application is approved and the flow proceeds to the “Yes” route of Step 104, and the data transmitting/receiving unit 120 receives, from the staff of the front middle office, an instruction to circulate the credit application data via the financial institution terminal 104, and circulates the approved credit application data to the credit department (Step 106). This is performed by, for example, the control card data preparing unit 122 which updates the “status ID” of the control card data (FIG. 3) to “2: credit application approve” and the “decision-making authority code” of the credit application data (FIG. 2) to the staff code (from the staff data of FIG. 4) of the circulation destination. Note that, as with Step 103, the staff code of the circulation destination can also be specified by the staff of the front middle office via the financial institution terminal 104, or a circulation route is held as data in advance so that the staff code of the circulation destination can also be set in accordance with this data.

On the other hand, in the case where there is any problem in checking the credit application content, the flow proceeds to the “No” route of Step 104, and the staff of the front office or front middle office can modify the credit application data via the financial institution terminal 104 (Step 105). The credit application data preparing unit 121 reflects the modified credit application data on the credit application data storage part 130.

Once the credit application data is circulated to the credit department, the staff of the credit department determines whether or not the credit data in the investigation card data (FIG. 5) has been updated as compared with the data at the time of preparing the credit application (Step 107). In the case where the credit data has been updated, the flow proceeds to the “Yes” route of Step 107, and the staff of the front office or front middle office can update the credit application data via the financial institution terminal 104 (Step 108). The credit application data preparing unit 121 reflects the updated credit application data on the credit application data storage part 130.

On the other hand, in the case where the credit data has not been updated, the flow proceeds to the “No” route of Step 107, and the staff of the credit department determines (makes a credit decision about), for example, whether or not a financing related party fulfills the terms of credit (Step 109). In the case where it does not fulfill the terms of credit, it is determined that a loan cannot be executed, and the flow proceeds to the “No” route of Step 109 and then this procedure is terminated.

On the other hand, in the case where it fulfills the terms of credit, the credit application is decided, and the flow proceeds to the “Yes” route of Step 109, and the data transmitting/receiving unit 120 receives, from the staff of the credit department, an instruction to circulate the credit application data via the financial institution terminal 104, and circulates the decided credit application data to the front middle office (Step 110). This is performed by, for example, the control card data preparing unit 122 which updates the “status ID” of the control card data (FIG. 3) to “3: credit application decide” and the “credit application decision” to “1: decide”). Note that, for example, the control can also be made so that the decided credit application data (FIG. 2) cannot be updated by using the “status ID” or “credit application decision”.

Once the credit application data is circulated to the front middle office from the credit department, the staff of the front middle office prepares the contract document (Step 111). This can be performed also by accessing the dedicated site, and on the basis of the contract content (input data) input by the staff, the contract data preparing unit 123 prepares the contract data. In this case, the control card data preparing unit 122 sets the “contract number” uniquely indicative of this contract data in the control card data (FIG. 3). Thus, the contract data and the control card data (FIG. 3) are linked. Moreover, in preparing the contract document, the signature by the customer is also included. For the signature by the customer, the customer can also sign via a dedicated site by using the customer terminal 103.

Next, the data transmitting/receiving unit 120 receives, from the staff of the front office, an instruction to circulate the contract data via the financial institution terminal 104, and circulates the contract data prepared in Step 111 to the middle back office (Step 112). This is performed by, for example, the control card data preparing unit 122 which updates the “status ID” of the control card data (FIG. 3) to “4: waiting for contract to be checked” and the “M/B branch code” and “MB staff code” to the branch code and staff code (from the staff data of FIG. 4) of the circulation destination. Note that the staff code of the circulation destination can also be specified by the staff of the front middle office via the financial institution terminal 104, or a circulation route is held as data in advance so that the staff code of the circulation destination can also be set in accordance with this data.

Once the contract data is circulated to the middle back office, the staff of the middle back office checks the contract document and credit application (Step 113). In the case where there is any flaw in the contract document or the like, the flow proceeds to the “No” route of Step 113, and the staff of the front office or front middle office can modify the credit application data and contract data via the financial institution terminal 104 (Step 114). In this case, the control can be made, for example, so that the loan procedure hereafter is not executed, by the control card data preparing unit 122 which updates the “contract document check” of the control card data (FIG. 3) to “1: in checking (in modifying)”.

On the other hand, in the case where there is no flaw in the contract document or the like, the flow proceeds to the “Yes” route of Step 113, and the data transmitting/receiving unit 120 receives, from the staff of the middle back office, an instruction to circulate the contract data via the financial institution terminal 104, and circulates the checked contract data to the back office (Step 115). This is performed by, for example, the control card data preparing unit 122 which updates the “status ID” of the control card data (FIG. 3) to “5: contract checked” and the “contract document check” to “2: checked”). Note that, for example, the control can also be made by using the “status ID” so that the contract data of the contract which has been checked cannot be updated. Similarly, whether or not to be able to update the credit application data (FIG. 2) can also be controlled (e.g., the control can be made so that the credit application data also cannot be updated in the case where the contract has been checked).

Once the contract data is circulated to the back office, the staff of the back office executes the loan procedure on the basis of the contract document, by using the financial institution terminal 104 (Step 116). This can also be performed by accessing the dedicated site. After Step 116, this procedure is terminated.

Moreover, even without through the check in Step 104 or the check in 107 in the flow chart of FIG. 7, the staff of the front office or front middle office can also voluntarily update the credit data (investigation card data (FIG. 5)) and/or credit application data (FIG. 2).

Accordingly, the present invention enables to reflect the credit data of a financing related party when updated even before decision, on a credit application, and enables to make a decision and in turn execute a loan on the basis of the latest credit data.

1. A method for updating an electronic credit application in crediting works, the method comprising:
receiving credit application content data input by a first staff, the credit application content data being prepared based on credit data of a financing related party;
preparing credit application data based on the received credit application content data;
receiving a first circulation instruction from the first staff;
circulating the credit application data to a second staff in response to the first circulation instruction;
receiving a second circulation instruction from the second staff;
approving the credit application data in response to the second circulation instruction and circulating the credit application data to a third staff;
receiving a third circulation instruction from the third staff, the third circulation instruction including a determination result whether or not the credit data corresponding to the credit application content data input by the first staff has been updated since preparing the credit application content data input by the first staff;
if the credit data has not been updated, approving the credit application data in response to the third circulation instruction and circulating the credit application data to the second staff;
if the credit data has been updated, prompting the second staff to update the credit application data without approving the credit application data, in response to the third circulation instruction;
receiving first update data of the credit application data; and
updating the credit application data based on the first update data.

2. The method according to claim 1, further comprising:
receiving contract content data input by the second staff;
preparing contract data based on the received contract content data;
receiving a fourth circulation instruction from the second staff;
circulating the contract data to a fourth staff in response to the fourth circulation instruction;
receiving a fifth circulation instruction from the fourth staff;
approving the contract data in response to the fifth circulation instruction and circulating the contract data to a fifth staff;
receiving an execution instruction from the fifth staff;
executing a loan procedure based on the contract data in response to the execution instruction;
receiving second update data of the contract data; and
updating the contract data based on the second update data.

3. The method according to claim 1, further comprising:
updating status data indicating credit application approval and loan execution statuses, in response to any one of the first to fifth circulation instructions, or the execution instruction;
determining, based on the status data, whether or not the credit application data or the contract data can be updated; and
determining, based on the status data, a staff who can update the credit application data or the contract data.

4. (canceled)

5. (canceled)

6. The method according to claim 2, further comprising:
updating status data indicating credit application approval and loan execution statuses, in response to any one of the first to fifth circulation instructions, or the execution instruction;
determining, based on the status data, whether or not the credit application data or the contract data can be updated; and
determining, based on the status data, a staff who can update the credit application data or the contract data.

7. A computer for updating an electronic credit application in crediting works, the computer being configured to:
receive credit application content data input by a first staff, the credit application content data being prepared based on credit data of a financing related party;
prepare credit application data based on the received credit application content data;
receive a first circulation instruction from the first staff;
circulate the credit application data to a second staff in response to the first circulation instruction;
receive a second circulation instruction from the second staff;
approve the credit application data in response to the second circulation instruction and circulating the credit application data to a third staff;
receive a third circulation instruction from the third staff, the third circulation instruction including a determination result whether or not the credit data corresponding to the credit application content data input by the first staff has been updated since preparing the credit application content data input by the first staff;
if the credit data has not been updated, approve the credit application data in response to the third circulation instruction and circulating the credit application data to the second staff;
if the credit data has been updated, prompt the second staff to update the credit application data without approving the credit application data, in response to the third circulation instruction;
receive first update data of the credit application data; and
update the credit application data based on the first update data.

8. A non-transitory computer readable storage medium including computer-executable instructions to cause a computer to execute the method for updating an electronic credit application in crediting works, the method comprising:
receiving credit application content data input by a first staff, the credit application content data being prepared based on credit data of a financing related party;
preparing credit application data based on the received credit application content data;
receiving a first circulation instruction from the first staff;
circulating the credit application data to a second staff in response to the first circulation instruction;
receiving a second circulation instruction from the second staff;
approving the credit application data in response to the second circulation instruction and circulating the credit application data to a third staff;
receiving a third circulation instruction from the third staff, the third circulation instruction including a determination result whether or not the credit data corresponding to the credit application content data input by the first staff has been updated since preparing the credit application content data input by the first staff;
if the credit data has not been updated, approving the credit application data in response to the third circulation instruction and circulating the credit application data to the second staff;
if the credit data has been updated, prompting the second staff to update the credit application data without approving the credit application data, in response to the third circulation instruction;
receiving first update data of the credit application data; and
updating the credit application data based on the first update data.
